(19) United States
(12) Patent Application Publication
(10) Pub. No.: US 2008/0169136 A1
(43) Pub. Date: Jul. 17, 2008

(54) Wheelchair With A Middle Wheel Drive, In Particular Raising Wheelchair

(75) Inventor: Bruno Meyer, Wohlen (CH)

Correspondence Address: MORRISS OBRYANT COMPAGNI, P.C., 734 EAST 200 SOUTH, SALT LAKE CITY, UT, 84102, US

(73) Assignee: LEVO AG WOHLEN, Wohlen (CH)

(21) Appl. No.: 11/547,983

(22) PCT Filed: Mar. 30, 2005
(86) PCT No.: PCT/CH2005/000182

§ 371 Date: Oct. 20, 2007

(30) Foreign Application Priority Data
Apr. 8, 2004 (CH) 622/04

(51) Int. Cl. A61G 5/04

(52) U.S. Cl. 180/15

(57) ABSTRACT

The wheelchair with middle wheel drive has a wheel frame (11) comprising a front portion (13) and a back portion (15) pivotally connected together by a hinge (17). At least one front wheel (23), two middle wheels (21) and at least one auxiliary wheel (25) are provided. It is important that the auxiliary wheel (25) is located between the front wheel (23) and the middle wheels (21) and at a distance from the running plane (27) of these wheels. On surmounting an obstacle (43) the gas spring (17) is biassed both by the front wheels (23) and the auxiliary wheel (25) and is released again on the further travel of the wheelchair. This facilitates surmounting of obstacles.

The invention refers to a wheelchair with middle wheel drive, in particular a raising wheelchair, with a wheel frame comprising a front portion and a back portion which are pivotally connected by a hinge and are swivelable relative to each other against the force of a spring, at least one front wheel, two middle wheels, at least one rear wheel and at least one auxiliary wheel.

In recent years “wheelchair with middle wheel drive” has become a notion for potential buyers of wheelchairs which permit turning around in a small space e.g. in an elevator. In order to turn on the spot the user of the wheelchair must only operate the control in such a way that the middle wheels turn in opposite directions. These middle wheels are arranged on the wheel frame in such a way that practically the whole weight of the user is acting on them. The front wheels and the rear wheels should not hinder the turning of the wheelchair. For this reason they are usually in the form of castor-wheels (U.S. Pat. No. 5,964,473). On certain wheelchairs of this kind only the rear wheels (U.S. Pat. No. 5,944,131) or only the front wheels (U.S. Pat. No. 5,904,214) are castor-wheels. The rear wheels and the front wheels, respectively, are usually located on a higher level, so that they are not touching an even floor. Touching the floor would somewhat impede turning of the wheelchair.

A particular challenge for wheelchair users is the surmounting of obstacles, e.g. of a curbstone. Already for wheelchairs without middle wheel drive the use of complimentary wheels or auxiliary wheels was proposed to permit easier surmounting of obstacles. For example, the AT-B-384 187 discloses a wheelchair with driven front wheels. In the rear part of the wheel frame two complimentary wheels are located to which, located on a two-armed support, a leading and a following auxiliary wheel are associated. This wheelchair, in contrast to a wheelchair with middle wheel drive, can not be turned on the spot. The EP-A-1 118 531 discloses a vehicle with four wheels or wheel pairs located behind each other and a complicated lever system facilitating the surmounting of obstacles. Also this vehicle can not turn on the spot.

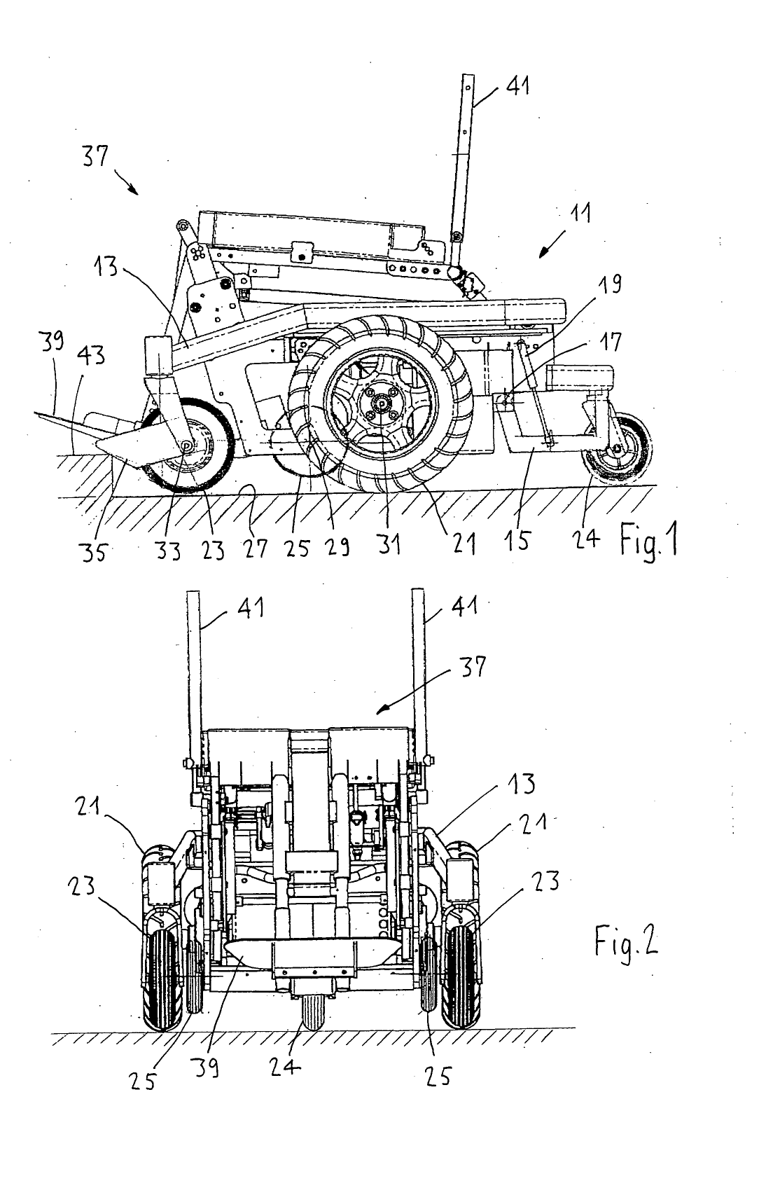

The larger the diameter of the wheel the easier the wheel can surmount an obstacle. Accordingly, e.g. the wheelchair according the previously cited AT-B-384 167 has front wheels with a relatively large diameter. However, this has the already previously mentioned disadvantage that the wheel chair can not be turned on the spot. In order to reduce this disadvantage and still be able to surmount relatively large obstacles the U.S. Pat. No. 5,964,473 proposes, with reference to FIGS. 1 to 8, to use a relatively small front wheel in combination with auxiliary wheels. The auxiliary wheels are located somewhat higher than the front wheel and therefore are not in contact with the floor. When the auxiliary wheels encounter an obstacle the front portion of the wheel frame is lifted and rotated with respect to the back portion against the force of a spring of the type ROSTA. This elevates also the front wheel so that it can easier surmount the obstacle, and also the middle wheels will be relieved so that they can easier climb on the obstacle. When on further motion of the wheelchair the front wheel is lifted from the floor and the middle wheels have partly surmounted the obstacle the energy previously stored in the spring by the lifting of the front portion of the wheel frame causes the front portion to move back into the initial position. This further facilitates surmounting of the obstacle. However, of disadvantage is the relatively long lever arm between the auxiliary wheels and the hinge, so that the obstacle provides only a relatively small rotation and therefore relatively little energy will be stored in the spring. This disadvantage is increased by the fact that on a rotation the storage of energy in the spring will only start when the rear wheel makes contact with the floor. Of disadvantage is also the steep spring characteristic of springs of the type ROSTA. Therefore, with such a wheelchair only relatively small obstacles can be surmounted.

It is therefore an object of the present invention to provide a wheel chair which permits also to surmount larger obstacles.

According to the invention this is obtained with a wheelchair of the initially mentioned kind in that the auxiliary wheel is located between the front wheels and the middle wheels and at a distance from the running plane of the wheels. Accordingly the lever arm between the auxiliary wheel and the hinge connecting the front portion of the wheel frame with the back portion thereof is relatively small so that on surmounting of an obstacle a relatively large movement takes place. Accordingly, relatively much energy is stored in the spring. Of advantage is also that the total rotation is used for storing energy, because the rear wheel must not first -be moved down to the ground as has been the case up until now.

The auxiliary wheel may be coupled to the middle wheels or be driven separately. This further facilitates surmounting of an obstacle.

Of particular advantage is a spring with a flat spring characteristic. In this respect gas springs are particularly suitable, because on these springs the force for biassing the spring remains practically constant over the whole distance. This permits energy storage over a long distance so that, on surmounting an obstacle, the middle wheels will be relieved over a longer time with practically constant force. Therefore they can surmount relatively large obstacles.

The axis of the auxiliary wheel may be located close to the axis of the middle wheels. Of advantage is a distance of the axis of the auxiliary wheel of about one third of the distance between the axis of the front wheel and the axis of the middle wheels. The auxiliary wheel is preferably adjustable in height. This permits an adjustment according to the weight of the user of the wheelchair.

The wheelchair has preferably two auxiliary wheels located in a lateral distance from each other.

On an embodiment of the invention the front portion and the back portion of the wheel frame are pivotally connected by a hinge in the region between the middle wheels and the rear wheels. While it is possible to have only one front wheel and/or auxiliary wheel it is of advantage to have two front wheels and two auxiliary wheels. It is also possible to provide two rear wheels.

An embodiment of the invention will now be described with reference to the drawing.

FIG. 1 shows a front view of the raising wheelchair.

FIGS. 1 and 2 disclose a raising wheelchair with middle wheel drive. One or more electric motors may serve as drive means. The wheel frame 11 comprises a front portion 13 and a back portion 15 which are pivotally connected by a hinge 17. The back portion 15 with the rear wheel 24 can be rotated counter clockwise against the force of the spring 19, preferably a gas spring. Located on the front portion 13 are the middle wheels 21, the front wheels 23 and the auxiliary wheels 25. The auxiliary wheels 25 are located between the front wheels 23 and the middle wheels 21 at a vertical distance from the running plane 27. The axis 29 of each auxiliary wheel 25 is located in horizontal direction close to the axis 31 of the middle wheels 21. This distance is preferably about one third of the distance between the axis of the front wheel 23 and the axis 31 of the middle wheel 21. On both sides of each front wheel 23 is a wedge 35 (not shown in FIG. 2). Instead of a wedge also a further auxiliary wheel or complementary wheel could find application as this is already described—as previously mentioned—in the U.S. Pat. No. 5,964,473 with reference to FIGS. 1 to 8.

Connected with a front portion 13 is a seat device 37 which on the embodiment shown is a raising mechanism. However, the seat device 37 can also be in the form of a usual seat of a wheelchair. Visible in the drawing are the foot rest 39 and the backrest support 41.

On surmounting of an obstacle 43, if it is sufficiently high, first the wedges 35 get into contact with the obstacle and elevate the front portion 13, thereby compressing the gas spring 19. A further compression takes place when the front wheels 23 move over the obstacle 43. When finally the auxiliary wheels 25 make contact with the obstacle 43 a relatively strong rotation of the front portion 13 takes place around the hinge 17 so that the gas spring 19 is further compressed and therefore on surmounting the obstacle relieves the middle wheels 21 over a long distance. When the middle wheels 21 have partly surmounted the obstacle the energy previously stored in the spring on lifting the front portion 13 of the wheel frame 11 causes the front portion 13 to move back into the initial position, thus facilitating surmounting the obstacle. The drive force is therefore sufficient to surmount also relatively high obstacles 43. As already initially mentioned it is of advantage to have the auxiliary wheel coupled to the middle wheels or to have it separately driven.

Summarizing the following can be stated: The wheelchair with middle wheel drive has a wheel frame 11 comprising a front portion 13 and a back portion 15 pivotally connected together by a hinge 17. At least one front wheel 23, two middle wheels 21 and at least one auxiliary wheel 25 are provided. It is important that the auxiliary wheel 25 is located between the front wheel 23 and the middle wheels 21 and at a distance from the running plane 27 of these wheels. On surmounting an obstacle 43 the gas spring 17 is biassed both by the front wheels 23 and the auxiliary wheel 25 and released again on the further travel of the wheelchair. This facilitates surmounting of obstacles.

1. A wheelchair with middle wheel drive, in particular raising wheel chair, with a wheel frame comprising:
a front portion and a back portion which are pivotally connected by a hinge and are swivelable relative to each other against the force of a spring,
at least one front wheel, two middle wheels, at least one rear wheel and at least one auxiliary wheel,
the auxiliary wheel located between the front wheel and the middle wheels and at a distance from the running plane of said wheels.

2. Wheelchair as claimed in claim 1, wherein the auxiliary wheel is coupled to a drive means for driving the middle wheels.

3. The wheelchair as claimed in claim 1, wherein an axis of the auxiliary wheel is located in horizontal direction proximate to an axis of the middle wheels.

4. The wheelchair as claimed in claim 3, wherein a horizontal distance of the axis of the auxiliary wheel is about one third of the distance of the front wheel from the axis of the middle wheels.

5. The wheelchair as claimed in claim 1 wherein the auxiliary wheel is adjustable in height.

6. The wheelchair as claimed in claim 1 wherein the spring has a flat spring characteristic.

7. The wheelchair as claimed in claim 6, wherein the spring is a gas spring.

8. The wheelchair as claimed in claim 1 wherein the front portion and the back portion of the wheel frame are pivotally connected by the hinge in the a region between the middle wheels and the rear wheel.

9. The wheelchair as claimed in claim 1 wherein two front wheels are provided.

10. The wheelchair as claimed in claim 1 wherein two rear wheels are provided.

11. The wheelchair as claimed in claim 1 wherein two auxiliary wheels are provided.

12. The wheelchair as claimed in claim 1 further comprising at least one of a wedge, a swivelable foot and a helping or complimentary wheel on both sides of the front wheel.
